(19) United States
(12) Patent Application Publication
(10) Pub. No.: US 2026/0277709 A1
(43) Pub. Date: Sep. 17, 2026

(54) SYNTHETIC DATA GENERATION FOR APPLICATION PROGRAMMING INTERFACE REQUEST PAYLOADS AND MOCK DEPENDENCY RESPONSES

(71) Applicant: Capital One Services, LLC, McLean, VA (US)

(72) Inventors: Carel de BRUYN, Prosper, TX (US); Alit PONKAEW, Allen, TX (US); David DUONG, Plano, TX (US)

(73) Assignee: Capital One Services, LLC, McLean, VA (US)

(21) Appl. No.: 19/080,685

(22) Filed: Mar. 14, 2025

(51) Int. Cl. G06F 9/54

(52) U.S. Cl. CPC G06F 9/541

(57) ABSTRACT

Systems and methods for generating application programming interface (API) request payloads and mock dependency responses. In some aspects, the system receives an API request schema for an API and a target output field and corresponding value for the API. The system generates, using a machine learning optimization algorithm, a plurality of candidate solutions. The system generates an API request to the API with each candidate solution to obtain one or more corresponding output values for the target output field. The system determines a fitness score of each candidate solution. The system adjusts, using the machine learning optimization algorithm, based on corresponding fitness scores, the plurality of candidate solutions. The system iteratively repeats generating the API request, determining the fitness score of each candidate solution, and adjusting the plurality of candidate solutions until the machine learning optimization algorithm converges on a final candidate solution.

### SUMMARY

In today's world, software applications often rely on APIs (Application Programming Interfaces) to communicate with other systems and services. Testing these APIs to ensure they work correctly can be challenging, especially when they depend on complex data from other sources. For example, a recommendation API might need to consider various pieces of information from user profiles and related history to make a decision. Creating test cases for such APIs, which include both the input data and the dependency data, can be time-consuming and difficult.

The systems and methods described herein address this challenge by using machine learning optimization algorithms to generate test cases for API request payloads and mock dependency responses. A motivation behind these systems and methods is to make the process of testing APIs more efficient and accurate. By automating the creation of test cases, a significant amount of time and resources that would otherwise be spent on manually generating the necessary data can be saved.

The systems and methods described herein address the complexities and inefficiencies inherent in traditional software testing methodologies. Conventional systems often rely on manual methods to create test cases for APIs. This involves manually crafting input data and dependency data, which can be a labor-intensive and error-prone process. Additionally, these conventional methods may not cover all possible scenarios, leading to incomplete testing and potential issues in the API's performance. The manual approach also makes it difficult to quickly adapt to changes in the API or its dependencies, further complicating the testing process.

The technical problem solved is the difficulty in creating test cases for APIs with complex dependencies. Traditional methods of generating test cases often require a lot of manual effort and can be prone to errors. The systems and methods described herein use machine learning to automatically generate candidate solutions, which include both the input data for the API and the mock responses from dependencies. These candidate solutions are then iteratively adjusted based on their fitness scores until a final solution that meets the desired criteria is reached.

The technical solution provided by the systems and methods described herein involves using optimization algorithms to search through possible fields in the input payload and dependency responses. The model evaluates the fitness of each candidate solution based on how well it meets the desired outcomes. This process continues until a suitable test case that accurately represents the scenario to be tested is found. This approach not only reduces the resources required to create test cases but also improves the overall efficiency and accuracy of the testing process.

The systems and methods described herein offer a practical benefit by significantly reducing the time and effort needed to create test cases for APIs with complex dependencies. By leveraging machine learning optimization algorithms, the generation of test cases can be automated, ensuring that they are accurate and consistent. This innovation helps improve the efficiency of testing software applications, ultimately leading to more reliable and robust APIs.

In some aspects, to address one or more of the technical problems described above, systems and methods are described herein for generating API request payloads and mock dependency responses. The system may receive an API request schema for an API and a target output field and corresponding value for the API. The system may generate, using a machine learning optimization algorithm, a plurality of candidate solutions, each candidate solution including an API request payload constructed based on the API request schema and including valid values for required fields in the API request schema. The system may generate an API request to the API with each candidate solution to obtain one or more corresponding output values for the target output field. The system may determine a fitness score of each candidate solution. The system may adjust, using the machine learning optimization algorithm, based on corresponding fitness scores, the plurality of candidate solutions. The system may iteratively repeat generating the API request, determining the fitness score of each candidate solution, and adjusting the plurality of candidate solutions until the machine learning optimization algorithm converges on a final candidate solution.

Various other aspects, features, and advantages of the disclosure will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative environment for generating API request payloads and mock dependency responses, in accordance with one or more implementations.

FIG. 2 shows an illustrative example of generating API request payloads and mock dependency responses, in accordance with one or more implementations.

FIG. 3 shows an illustrative architecture for a system for generating API request payloads and mock dependency responses, in accordance with one or more implementations.

FIG. 4 shows a flowchart of the operations involved in implementing generating API request payloads and mock dependency responses, in accordance with one or more implementations.

### DETAILED DESCRIPTION

In the following description, for the purposes of explanation, numerous specific details are set forth in order to provide a thorough understanding of the implementations of the systems and methods described herein. It will be appreciated, however, by those having skill in the art, that the implementations may be practiced without these specific details or with an equivalent arrangement. In other cases, well-known structures and devices are shown in block diagram form in order to avoid unnecessarily obscuring the implementations.

Testing APIs to ensure they work correctly can be challenging, especially when they depend on complex data from other sources. For example, an e-commerce recommendation API might need to consider various pieces of information from user profiles and purchase history to make a decision. Similarly, a loan approval API might need to evaluate various pieces of information from a credit report to make a decision. Creating test cases for such APIs, which include both the input data and the dependency data, can be time-consuming and difficult. The systems and methods described herein address this challenge by using machine learning optimization algorithms to generate test cases for API request payloads and mock dependency responses, including synthetic data.

In some aspects, the systems and methods described herein improve over conventional approaches to software testing by introducing a system for generating API request payloads and mock dependency responses. Conventional systems often rely on manual methods to create test cases for APIs. This involves manually crafting input data and dependency data, which can be a labor-intensive and error-prone process. Additionally, these conventional methods may not cover all possible scenarios, leading to incomplete testing and potential issues in the API's performance. For instance, in the case of a loan approval API, manually generating various credit report scenarios to test different loan approval outcomes can be extremely challenging. Similarly, for an e-commerce recommendation API, creating diverse user profiles and purchase histories to test the recommendation logic can be cumbersome. The manual approach also makes it difficult to quickly adapt to changes in the API or its dependencies, further complicating the testing process.

The systems and methods described herein use machine learning to automatically generate candidate solutions, which include both the input data for the API and the mock responses from dependencies, potentially using synthetic data. These candidate solutions are then iteratively adjusted based on their fitness scores until a final solution that meets the desired criteria is reached. This approach not only reduces the resources required to create test cases but also improves the overall efficiency and accuracy of the testing process. By leveraging machine learning optimization algorithms, the generation of test cases can be automated, ensuring that they are accurate and consistent. This innovation helps improve the efficiency of testing software applications, ultimately leading to more reliable and robust APIs.

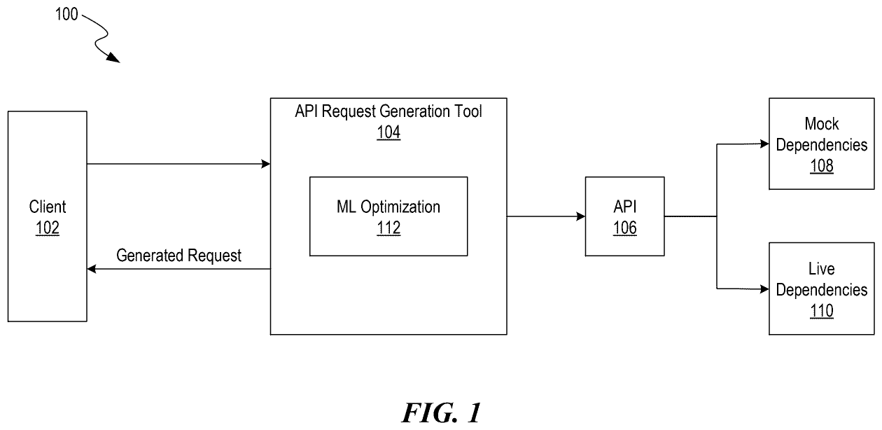

FIG. 1 shows an illustrative environment 100 for generating API request payloads and mock dependency responses, in accordance with one or more implementations. Environment 100 may significantly enhance the accuracy and efficiency of software testing by automatically generating API request payloads and mock dependency responses. This environment is particularly useful for testing APIs with complex dependencies, such as those used in e-commerce recommendation systems or loan approval processes, where the input data and dependency data can be intricate and varied.

Client module 102 may send API details to the API request generation tool 104. These details may include the URL, headers, API request schema, mock dependency API response schema, static values, field constraints, or other suitable information. The API request schema indicates how the request body to the API should be structured. The mock dependency API response schema indicates how the mock dependency response body should be structured. Static values include values in the request body that can be static and should not be changed by the tool. Field constraints include constraints for every non-static field, e.g., ranges, list of values, etc. This may reduce the search space of the tool.

Additionally, the client module 102 may specify the desired response, including the desired output fields (e.g., XPath/JsonPath) and values or other suitable information. The desired output fields and values include the output values the request and mock dependency responses should be generated for. These can be given as a XPath/JsonPath expression along with acceptable values for each desired field (acceptable values can be single values, ranges, lists, etc.). For example, in the case of an e-commerce recommendation API, the client module might specify user profile data and purchase history as input, along with the expected recommendation results. Similarly, for a loan approval API, the client module might provide applicant data and credit report details, along with the expected loan approval decision.

API request generation tool 104 may leverage machine learning optimization algorithms to generate the required test cases. It may include an ML optimization module 112, which can utilize various optimization techniques such as genetic algorithms, particle swarm optimization, or other suitable models. The ML optimization module 112 may generate candidate solutions in the form of API request payloads and mock dependency responses. These solutions may be iteratively refined based on their fitness scores, which measure how closely the generated outputs match the desired response. For instance, in the loan approval API example, the fitness function may evaluate how accurately the generated credit report data leads to the expected loan decision.

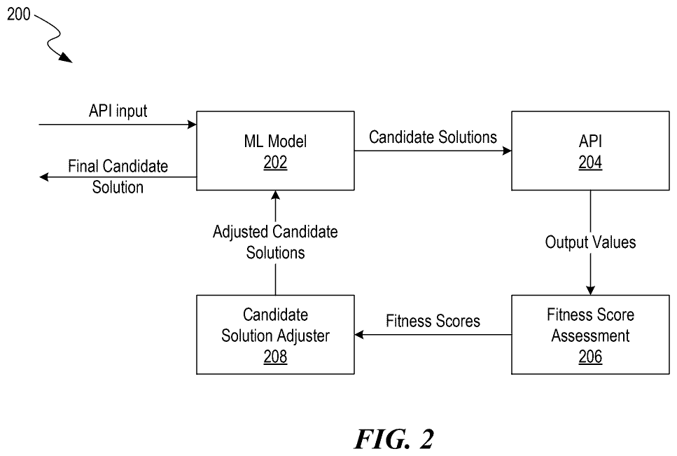

The API request generation tool 104 may interact with several other modules to achieve its functionality. The API module 106 handles the actual API requests, while the mock dependencies module 108 simulates the responses from dependent services. This is particularly useful for testing scenarios where live dependency data is not available or practical to use. The live dependencies module 110, on the other hand, allows for real-time interaction with actual dependent services when needed. This combination of mock and live dependencies ensures comprehensive testing coverage for various scenarios. FIG. 2 provides more details with respect to API request generation tool 104.

Once the API request generation tool 104 has generated the appropriate request payloads and mock dependency responses, it returns the generated request to the client module 102. This automated process significantly reduces the manual effort required to create test cases, ensuring that they are accurate and consistent. By leveraging machine learning optimization algorithms, the systems and methods described herein improve the efficiency of testing software applications, ultimately leading to more reliable and robust APIs. This approach is particularly beneficial for complex systems like e-commerce recommendation engines and loan approval processes, where the accuracy and efficiency of testing are critical.

FIG. 2 shows an illustrative example 200 of generating API request payloads and mock dependency responses, in accordance with one or more implementations. FIG. 2 demonstrates the process of using machine learning optimization algorithms, such as genetic algorithms and particle swarm optimization, to generate accurate and efficient test cases for APIs with complex dependencies.

Genetic algorithms (GAs) are a type of optimization algorithm inspired by the process of natural selection. They are used to find approximate solutions to optimization and search problems. GAs work by evolving a population of candidate solutions over several generations. Each candidate solution is evaluated based on a fitness function, and the best-performing solutions are selected to create a new generation through operations such as crossover (combining parts of two solutions) and mutation (randomly altering parts of a solution). This process continues until an optimal or satisfactory solution is found.

Another powerful optimization algorithm that can be used is Particle Swarm Optimization (PSO). PSO is inspired by the social behavior of birds flocking or fish schooling. In PSO, a population of candidate solutions, called particles, move through the solution space by following the current optimum particles. Each particle adjusts its position based on its own experience and the experience of neighboring particles, converging towards the best solution over time. This method is particularly effective for continuous optimization problems and can be used as an alternative to genetic algorithms.

The process begins with the ML model 202, which receives the API input, including the metadata of the API and its mock dependencies, along with the desired output. For example, in the case of a loan approval API, the input might include applicant data and the desired loan approval decision. Similarly, for an e-commerce recommendation API, the input might include user profile data and the desired product recommendations.

As part of the processing, the ML model 202 generates an initial population of candidate solutions. These candidate solutions represent different combinations of API request payloads and mock dependency responses. For instance, in the loan approval API example, the candidate solutions might include various credit report scenarios. In the e-commerce recommendation API example, the candidate solutions might include different user profiles and purchase histories.

The generated candidate solutions are then provided to the API module 204, which calls the API with each candidate solution and outputs the resulting values. These values are then passed to the fitness score assessment module 206. The fitness score assessment module 206 evaluates the output values by comparing them to the desired output values. It generates fitness scores based on the distance between the actual output and the desired output. For example, if the desired output is a loan approval with a specific APR, the fitness score would measure how closely the actual output matches this desired outcome.

The fitness scores are then provided to the candidate solution adjuster module 208. The candidate solution adjuster module 208 uses the fitness scores to select the best-performing candidate solutions. These selected solutions undergo genetic operations such as crossover and mutation to create a new generation of candidate solutions. Crossover involves combining parts of two solutions to create a new solution, while mutation involves randomly altering parts of a solution to introduce variability. This iterative process continues, with the adjusted candidate solutions being fed back into the ML model 202 for further refinement.

The process repeats through the ML model 202, API module 204, fitness score assessment module 206, and candidate solution adjuster module 208 until the ML model 202 converges on the final candidate solution. This final candidate solution represents the optimal combination of API request payload and mock dependency response that produces the desired output. For example, in the loan approval API scenario, the final candidate solution might be a specific credit report that leads to the desired loan approval decision. In the e-commerce recommendation API scenario, the final candidate solution might be a user profile and purchase history that results in the desired product recommendations.

Once the ML model 202 converges on the final candidate solution, it sends this solution back to the client. This automated process significantly reduces the manual effort required to create test cases, ensuring that they are accurate and consistent. By leveraging machine learning optimization algorithms, such as genetic algorithms and particle swarm optimization, the systems and methods described herein improve the efficiency of testing software applications, ultimately leading to more reliable and robust APIs. This approach is particularly beneficial for complex systems like loan approval processes and e-commerce recommendation engines, where the accuracy and efficiency of testing are critical.

It is noted that while genetic algorithms and particle swarm optimization are powerful tools, other optimization algorithms can also be used depending on the specific requirements and characteristics of the problem. For instance, simulated annealing, ant colony optimization, and differential evolution are other examples of optimization techniques that can be employed. The choice of algorithm can be tailored to the specific needs of the API testing scenario, ensuring the best possible results.

In summary, the use of machine learning optimization algorithms provides a robust method for generating API request payloads and mock dependency responses. By mimicking natural processes or social behaviors, these algorithms can efficiently search through a vast space of possible solutions to find the ones that best meet the desired criteria. This makes them a suitable choice for automating the creation of test cases for APIs with complex dependencies, ensuring thorough and accurate testing while minimizing manual effort.

In some embodiments, consider an application decisioning API that calls a third-party credit report API and uses the results in risk model calculations and other business rules like approve/decline rules, APR assignment, credit policies, and so on. The credit report is very complex, containing numerous fields and intricate data relationships, making it challenging to manually create a mock of it for desired outputs of the decisioning API. Additionally, the business rules applied to the credit report data are also very complex, involving multiple layers of logic and calculations. In this context, a tool that can generate a sample request and sample dependency response (credit report) would be extremely useful.

The systems and methods described herein provide such a tool. By simply providing the metadata of the API and its mock dependencies, along with a desired output, the tool can automatically generate the necessary test cases. This includes both the API request payload and the mock dependency response. For example, in the case of the decisioning API, the tool can generate a sample credit report that will lead to a specific decision outcome, such as an approval or a particular APR assignment. This automation significantly reduces the manual effort required and ensures that the test cases are accurate and consistent.

The tool can manage mock API outputs directly, which is faster and more efficient for testing purposes. Alternatively, it can send the generated requests and responses to a virtualization server, which can simulate the behavior of the actual dependencies. This flexibility allows for comprehensive testing in various environments. For instance, the tool can be run in a non-production instance using both live and mock dependencies to thoroughly test the API's behavior under different scenarios. In a production instance, the tool can use live dependencies only, ensuring that the API performs correctly in real-world conditions.

The core of the tool's functionality lies in its use of machine learning optimization algorithms, such as Particle Swarm Optimization (PSO) or Genetic Algorithms (GAs). These algorithms are designed to find the optimal API request and mock dependency responses that will produce the desired output fields. The tool does this by searching through the valid values of the non-static fields, calling the API multiple times to determine the fitness of each solution in each iteration of the optimization algorithm. This iterative process ensures that the generated test cases are as close as possible to the desired outcomes.

The fitness of a solution is calculated based on the distance from the output of the API call to the desired output values. This distance is used to generate a fitness score, which guides the optimization algorithm in adjusting the candidate solutions. The result is a request and mock dependency response payload that is calculated to be the closest to the desired response fields. This approach ensures that the generated test cases are highly accurate and relevant to the specific scenarios being tested.

For example, in the case of the decisioning API, the tool might generate a credit report with specific values that lead to an approval decision with a particular APR. The tool would start with an initial set of candidate solutions, each representing a different combination of input data and dependency responses. It would then call the API with each candidate solution, evaluate the output, and calculate the fitness score based on how closely the output matches the desired decision outcome. The optimization algorithm would iteratively adjust the candidate solutions, refining the input data and dependency responses until the best possible test case is found.

This process is illustrated in FIG. 2, which shows an example 200 of generating API request payloads and mock dependency responses. In another example, consider an e-commerce recommendation API that needs to generate personalized product recommendations based on user profiles and purchase history. The tool can generate synthetic user profiles and purchase histories that lead to specific recommendation outcomes. By providing the metadata of the recommendation API and the desired recommendations, the tool can automatically generate the necessary test cases. This ensures that the recommendation logic is thoroughly tested and performs correctly under various scenarios.

The tool's ability to generate synthetic data is particularly valuable in scenarios where real data is not available or practical to use. For instance, in the case of the credit report API, generating synthetic credit reports allows for comprehensive testing without the need for actual credit data, which may be sensitive or difficult to obtain. Similarly, generating synthetic user profiles for the recommendation API allows for extensive testing without relying on real user data.

Overall, the systems and methods described herein provide a powerful and flexible tool for generating test cases for APIs with complex dependencies. By leveraging machine learning optimization algorithms, the tool can automatically generate accurate and consistent test cases, significantly reducing the manual effort required and improving the efficiency of the testing process. This approach ensures that APIs are thoroughly tested and perform correctly under various scenarios, ultimately leading to more reliable and robust software applications.

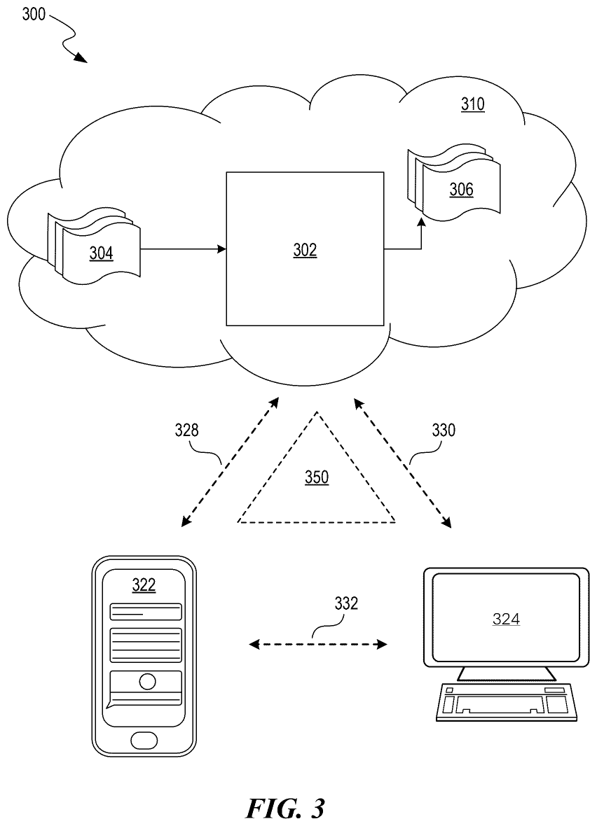

FIG. 3 is an illustrative architecture for a system 300 for generating API request payloads and mock dependency responses, in accordance with one or more implementations. As shown in FIG. 3, system 300 may include mobile device 322 and user terminal 324 (either type of device may be a “user device” as referred to herein, though a user device may additionally or alternatively include other types of devices as well). While shown as a smartphone and a personal computer, respectively, in FIG. 3, it should be noted that mobile device 322 and user terminal 324 may be any computing device, including, but not limited to, a laptop computer, a tablet computer, a hand-held computer, or other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, those operations may, in some implementations, be performed by other components of system 300. As an example, while one or more operations are described herein as being performed by components of mobile device 322, those operations may, in some implementations, be performed by components of cloud components 310. In some implementations, the various computers and systems described herein may include one or more computing devices that are programmed to perform the described functions. Additionally, or alternatively, multiple users may interact with system 300 and/or one or more components of system 300. For example, in one implementation, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., based on output data received from system 300).

Additionally, as mobile device 322 is shown as a touchscreen smartphone, this display also acts as a user input interface. It should be noted that in some implementations, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic database query responses using ensemble prediction by correlating probability models with non-homogenous time dependencies to generate time-specific data processing predictions.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communication networks or combinations of communication networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include a server 302 for implementing one or more implementations described with respect to FIGS. 1-4. For example, server 302 may implement a portion or all of the functionality described with respect to FIGS. 1-4. Server 302 may receive input data 304 from mobile device 322, execute the operation to process the input data 304, and transmit output data 306 to user terminal 324. Cloud components 310 may also include control circuitry configured to perform the various operations needed to generate API request payloads and mock dependency responses, according to one or more implementations.

In some implementations, cloud components 310 include an artificial intelligence model. The artificial intelligence model may take inputs and provide outputs. The inputs may include multiple datasets, such as a training dataset and a test dataset. In some implementations, the outputs may be fed back to the artificial intelligence model as input to train the artificial intelligence model (e.g., alone or in conjunction with user indications of the accuracy of the outputs, with labels associated with the inputs, or with other reference feedback information). For example, the system may receive a first labeled feature input, wherein the first labeled feature input is labeled with a known prediction for the first labeled feature input. The system may then train the artificial intelligence model to classify the first labeled feature input with the known prediction.

In another implementation, the artificial intelligence model may update its configurations (e.g., weights, biases, or other parameters) based on the assessment of its prediction and reference feedback information (e.g., user indication of accuracy, reference labels, or other information). In another implementation, where the artificial intelligence model is a neural network, connection weights may be adjusted to reconcile differences between the neural network's prediction and the reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the artificial intelligence model may be trained to generate better predictions.

In some implementations, the artificial intelligence model may include an artificial neural network. In such implementations, the artificial intelligence model may include an input layer and one or more hidden layers. Each neural unit of the artificial intelligence model may be connected with many other neural units of the artificial intelligence model. Such connections can be enforcing or inhibitory in their effect on the activation state of connected neural units. In some implementations, each individual neural unit may have a summation function that combines the values of all of its inputs together. In some implementations, each connection (or the neural unit itself) may have a threshold function that the signal must surpass before it propagates to other neural units. The artificial intelligence model may be self-learning and trained, rather than explicitly programmed, and can perform significantly better in certain areas of problem solving as compared to traditional computer programs. During training, an output layer of the artificial intelligence model may correspond to a classification of the artificial intelligence model, and an input known to correspond to that classification may be input into an input layer of the artificial intelligence model during training. During testing, an input without a known classification may be input into the input layer, and a determined classification may be output.

In some implementations, the artificial intelligence model may include multiple layers (e.g., where a signal path traverses from front layers to back layers). In some implementations, backpropagation techniques may be utilized by the artificial intelligence model where forward stimulation is used to reset weights on the “front” neural units. In some implementations, stimulation and inhibition for the artificial intelligence model may be more free flowing, with connections interacting in a more chaotic and complex fashion. During testing, an output layer of the artificial intelligence model may indicate whether or not a given input corresponds to a classification of the artificial intelligence model.

System 300 also includes application programming interface (API) layer 350. API layer 350 may allow the system to communicate across different devices. In some implementations, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some implementations, the system architecture may use a microservice approach. Such systems may use two types of layers: Front-End Layer and Back-End Layer, where microservices reside. In this kind of architecture, the role of the API layer 350 may provide integration between the Front-End Layer and the Back-End Layer. In such cases, API layer 350 may use RESTful APIs (exposition to front-end or event communication between microservices). API layer 350 may use AMQP (e.g., Kafka, RabbitMQ, etc.). API layer 350 may use incipient usage of new communication protocols such as gRPC, Thrift, etc.

In some implementations, the system architecture may use an open API approach. In such cases, API layer 350 may use commercial or open-source API platforms and their modules. API layer 350 may use a developer portal. API layer 350 may use strong security constraints applying WAF and DDoS protection, and API layer 350 may use RESTful APIs as standard for external integration.

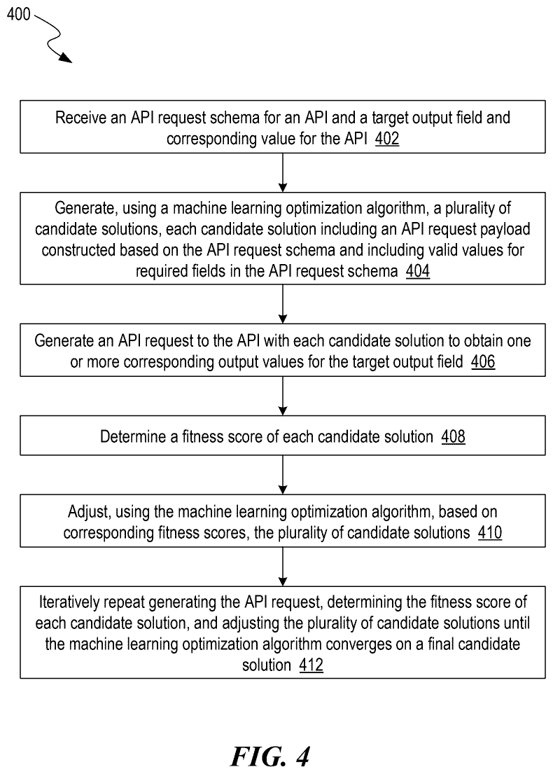

FIG. 4 shows a flowchart of the operations involved in implementing generating API request payloads and mock dependency responses, in accordance with one or more implementations. For example, process 400 may represent the operations taken by one or more devices discussed in relation to FIGS. 1-3.

At operation 402, process 400 (e.g., using one or more components in system 300 (FIG. 3)) may receive an API request schema for an API, a mock dependency API response schema for the API, and one or more target output fields and corresponding values for the API. The API request schema may define structure and format of data to be included in an API request to the API, including required fields, data types, and field constraints. The mock dependency API response schema may define structure and format of data expected to be returned by one or more mock dependency APIs, including required fields, data types, and field constraints.

For example, consider a loan approval API that requires applicant data such as name, address, income, and credit score. The API request schema would specify that the request must include these fields, along with their respective data types (e.g., string, integer) and any constraints (e.g., income must be a positive number). Similarly, the mock dependency API response schema for a credit report API might specify fields such as credit score, credit history, and outstanding debts, along with their data types and constraints.

In some embodiments, process 400 may validate, for each candidate solution, proposed values for required fields in the API request payload based on data types and field constraints from the API request schema. This may ensure that the generated test cases adhere to the defined structure and constraints, maintaining the integrity of the test data.

In some embodiments, process 400 may validate, for each candidate solution, proposed values for required fields in the one or more mock dependency API responses based on data types and field constraints from the mock dependency API response schema. This validation step may ensure that the mock dependency responses are consistent with the expected format and constraints.

In some embodiments, process 400 may drop output values from a live version of a mocked API from the mock dependency API response schema. This may allow the process to focus on the relevant fields and values needed for testing, improving efficiency.

At operation 404, process 400 may generate, using a machine learning optimization algorithm, a plurality of candidate solutions. Each candidate solution may include an API request payload constructed based on the API request schema and including valid values for required fields in the API request schema that are consistent with data types and field constraints in the API request schema. Each candidate solution may include one or more mock dependency API responses constructed based on the mock dependency API response schema and including valid values for required fields in the mock dependency API response schema that are consistent with data types and field constraints in the mock dependency API response schema.

For instance, in the loan approval API example, the initial candidate solutions might include various combinations of applicant data and credit report scenarios. These combinations are generated to explore different possible inputs and their effects on the API's output.

In some embodiments, generating the plurality of candidate solutions may include randomly generating initial values for required fields in the API request payload and the one or more mock dependency API responses based on field constraints in the API request schema and the mock dependency API response schema, respectively. This random generation may provide a diverse set of starting points for the optimization process.

At operation 406, process 400 may generate an API request to the API with each candidate solution to obtain one or more corresponding output values for the one or more target output fields. For example, API module 204 in FIG. 2 calls the API with each candidate solution and captures the resulting output values. For example, the process might call the loan approval API with different combinations of applicant data and credit report scenarios, capturing the resulting loan approval decisions and APR assignments.

In some embodiments, generating the API request to the API with each candidate solution may include generating the API request for transmission to a virtualization server configured to execute the API. This may allow for efficient testing in a controlled environment.

At operation 408, process 400 may determine a fitness score of each candidate solution by measuring a distance between the one or more corresponding output values and target values for the one or more target output fields. For example, fitness score assessment module 206 in FIG. 2 evaluates the output values by comparing them to the desired output values and generates fitness scores based on the distance between the actual output and the desired output. For example, if the desired output is a loan approval with a specific APR, the fitness score would measure how closely the actual output matches this desired outcome.

In some embodiments, process 400 may apply a weighted scoring system to prioritize a portion of the one or more target output fields over others based on corresponding weights. This may allow for more nuanced optimization, focusing on the most critical aspects of the output.

At operation 410, process 400 may adjust, using the machine learning optimization algorithm, based on corresponding fitness scores, the plurality of candidate solutions to reduce an expected distance between the one or more corresponding output values and target values for the one or more target output fields. For example, candidate solution adjuster module 208 in FIG. 2 uses the fitness scores to refine the candidate solutions. For instance, the process might adjust the applicant data and credit report scenarios to improve the accuracy of the loan approval decisions and APR assignments.

In some embodiments, adjusting the plurality of candidate solutions may include introducing random mutations to the plurality of candidate solutions to expand a search space of potential solutions. This may introduce variability and helps avoid local optima.

In some embodiments, adjusting the plurality of candidate solutions may include using one or more crossover techniques, combining elements from multiple candidate solutions to create new candidate solutions. This may mimic the genetic algorithm approach, combining the strengths of different solutions.

At operation 412, process 400 may iteratively repeat generating the API request, determining the fitness score of each candidate solution, and adjusting the plurality of candidate solutions until the machine learning optimization algorithm converges on a final candidate solution that is within a threshold fitness score. Process 400 may execute one or more test cases based on the final candidate solution and corresponding API request payload and mock dependency API responses. This iterative process is similar to the loop described in FIG. 2, where the ML model 202, API module 204, fitness score assessment module 206, and candidate solution adjuster module 208 work together to refine the candidate solutions until the optimal combination is found.

In some embodiments, the machine learning optimization algorithm may converge on the final candidate solution when a termination condition is met based on a predefined number of iterations or based on the final candidate solution being within a threshold fitness score. This may ensure that the process completes in a reasonable time frame while achieving the desired accuracy.

In summary, process 400 leverages machine learning optimization algorithms to generate accurate and efficient test cases for APIs with complex dependencies. By receiving the API request schema, mock dependency API response schema, and target output fields, the process can automatically generate, evaluate, and refine candidate solutions until the optimal combination is found. This approach may ensure thorough and accurate testing while minimizing manual effort, ultimately leading to more reliable and robust APIs.

It is contemplated that the operations or descriptions of FIG. 4 may be used with any other implementation of this disclosure. In addition, the operations and descriptions described in relation to FIG. 4 may be done in alternative orders or in parallel to further the purposes of this disclosure. For example, each of these operations may be performed in any order, in parallel, or simultaneously to reduce lag or increase the speed of the system or method. Furthermore, it should be noted that any of the devices or equipment discussed in relation to FIGS. 1-3 could be used to perform one or more of the operations in FIG. 4.

The above-described implementations of the present disclosure are presented for purposes of illustration and not of limitation, and the present disclosure is limited only by the claims that follow. Furthermore, it should be noted that the features and limitations described in any one implementation may be applied to any other implementation herein, and flowcharts or examples relating to one implementation may be combined with any other implementation in a suitable manner, done in different orders, or done in parallel. In addition, the systems and methods described herein may be performed in real time. It should also be noted that the systems and/or methods described above may be applied to, or used in accordance with, other systems and/or methods.

The present techniques for generating API request payloads and mock dependency responses will be better understood with reference to the following enumerated implementations:
1. A method for generating application programming interface (API) request payloads and mock dependency responses, comprising: receiving an API request schema for an API, a mock dependency API response schema for the API, and one or more target output fields and corresponding values for the API, wherein the API request schema defines structure and format of data to be included in an API request to the API, including required fields, data types, and field constraints; wherein the mock dependency API response schema defines structure and format of data expected to be returned by one or more mock dependency APIs, including required fields, data types, and field constraints; generating, using a machine learning optimization algorithm, a plurality of candidate solutions, each candidate solution including: an API request payload constructed based on the API request schema and including valid values for required fields in the API request schema that are consistent with data types and field constraints in the API request schema; and one or more mock dependency API responses constructed based on the mock dependency API response schema and including valid values for required fields in the mock dependency API response schema that are consistent with data types and field constraints in the mock dependency API response schema; generating an API request to the API with each candidate solution to obtain one or more corresponding output values for the one or more target output fields; determining a fitness score of each candidate solution by measuring a distance between the one or more corresponding output values and target values for the one or more target output fields; adjusting, using the machine learning optimization algorithm, based on corresponding fitness scores, the plurality of candidate solutions to reduce an expected distance between the one or more corresponding output values and target values for the one or more target output fields; iteratively repeating generating the API request, determining the fitness score of each candidate solution, and adjusting the plurality of candidate solutions until the machine learning optimization algorithm converges on a final candidate solution that is within a threshold fitness score; and executing one or more test cases based on the final candidate solution and corresponding API request payload and mock dependency API responses.
2. A method for generating application programming interface (API) request payloads and mock dependency responses, comprising: receiving an API request schema for an API, a mock dependency API response schema for the API, and one or more target output fields and corresponding values for the API; generating, using a machine learning optimization algorithm, a plurality of candidate solutions, each candidate solution including: an API request payload constructed based on the API request schema and including valid values for required fields in the API request schema; and one or more mock dependency API responses constructed based on the mock dependency API response schema and including valid values for required fields in the mock dependency API response schema; generating an API request to the API with each candidate solution to obtain one or more corresponding output values for the one or more target output fields; determining a fitness score of each candidate solution by measuring a distance between the one or more corresponding output values and target values for the one or more target output fields; adjusting, using the machine learning optimization algorithm, based on corresponding fitness scores, the plurality of candidate solutions to reduce an expected distance between the one or more corresponding output values and target values for the one or more target output fields; and iteratively repeating generating the API request, determining the fitness score of each candidate solution, and adjusting the plurality of candidate solutions until the machine learning optimization algorithm converges on a final candidate solution.
3. A method, the method comprising: receiving an API request schema for an API and a target output field and corresponding value for the API; generating, using a machine learning optimization algorithm, a plurality of candidate solutions, each candidate solution including an API request payload constructed based on the API request schema and including valid values for required fields in the API request schema; generating an API request to the API with each candidate solution to obtain one or more corresponding output values for the target output field; determining a fitness score of each candidate solution; adjusting, using the machine learning optimization algorithm, based on corresponding fitness scores, the plurality of candidate solutions; and iteratively repeating generating the API request, determining the fitness score of each candidate solution, and adjusting the plurality of candidate solutions until the machine learning optimization algorithm converges on a final candidate solution.
4. The method of any one of the preceding implementations, wherein the API request schema defines structure and format of data to be included in an API request to the API, including required fields, data types, and field constraints, further comprising: validating, for each candidate solution, proposed values for required fields in the API request payload based on data types and field constraints from the API request schema.
5. The method of any one of the preceding implementations, wherein the mock dependency API response schema defines structure and format of data expected to be returned by one or more mock dependency APIs, including required fields, data types, and field constraints, further comprising: validating, for each candidate solution, proposed values for required fields in the one or more mock dependency API responses based on data types and field constraints from the mock dependency API response schema.
6. The method of any one of the preceding implementations, wherein generating the plurality of candidate solutions comprises: randomly generating initial values for required fields in the API request payload and the one or more mock dependency API responses based on field constraints in the API request schema and the mock dependency API response schema, respectively.
7. The method of any one of the preceding implementations, further comprising: executing one or more test cases based on the final candidate solution and corresponding API request payload and mock dependency API responses.
8. The method of any one of the preceding implementations, further comprising: applying a weighted scoring system to prioritize a portion of the one or more target output fields over others based on corresponding weights.
9. The method of any one of the preceding implementations, wherein adjusting the plurality of candidate solutions comprises: introducing random mutations to the plurality of candidate solutions to expand a search space of potential solutions.
10. The method of any one of the preceding implementations, wherein adjusting the plurality of candidate solutions comprises: using one or more crossover techniques, combining elements from multiple candidate solutions to create new candidate solutions.
11. The method of any one of the preceding implementations, wherein the machine learning optimization algorithm converges on the final candidate solution when a termination condition is met based on a predefined number of iterations or based on the final candidate solution being within a threshold fitness score.
12. The method of any one of the preceding implementations, further comprising: dropping output values from a live version of a mocked API from the mock dependency API response schema.
13. The method of any one of the preceding implementations, wherein generating the API request to the API with each candidate solution comprises generating the API request for transmission to a virtualization server configured to execute the API.
14. One or more non-transitory, computer-readable media storing instructions that, when executed by a data processing apparatus, cause the data processing apparatus to perform operations comprising those of any of implementations 1-13.
15. A system comprising: one or more processors; and memory storing instructions that, when executed by the processors, cause the processors to effectuate operations comprising those of any of implementations 1-13.
16. A system comprising means for performing any of implementations 1-13.

What is claimed is:

1. A system for generating application programming interface (API) request payloads and mock dependency responses, comprising:
one or more processors; and
one or more non-transitory, computer-readable media comprising instructions that, when executed by the one or more processors, cause operations comprising:
receiving an API request schema for an API, a mock dependency API response schema for the API, and one or more target output fields and corresponding values for the API,
wherein the API request schema defines structure and format of data to be included in an API request to the API, including required fields, data types, and field constraints;
wherein the mock dependency API response schema defines structure and format of data expected to be returned by one or more mock dependency APIs, including required fields, data types, and field constraints;
generating, using a machine learning optimization algorithm, a plurality of candidate solutions, each candidate solution including:
an API request payload constructed based on the API request schema and including valid values for required fields in the API request schema that are consistent with data types and field constraints in the API request schema; and
one or more mock dependency API responses constructed based on the mock dependency API response schema and including valid values for required fields in the mock dependency API response schema that are consistent with data types and field constraints in the mock dependency API response schema;
generating an API request to the API with each candidate solution to obtain one or more corresponding output values for the one or more target output fields;
determining a fitness score of each candidate solution by measuring a distance between the one or more corresponding output values and target values for the one or more target output fields;
adjusting, using the machine learning optimization algorithm, based on corresponding fitness scores, the plurality of candidate solutions to reduce an expected distance between the one or more corresponding output values and target values for the one or more target output fields;
iteratively repeating generating the API request, determining the fitness score of each candidate solution, and adjusting the plurality of candidate solutions until the machine learning optimization algorithm converges on a final candidate solution that is within a threshold fitness score; and
executing one or more test cases based on the final candidate solution and corresponding API request payload and mock dependency API responses.

2. A method for generating application programming interface (API) request payloads and mock dependency responses, comprising:
receiving an API request schema for an API, a mock dependency API response schema for the API, and one or more target output fields and corresponding values for the API;
generating, using a machine learning optimization algorithm, a plurality of candidate solutions, each candidate solution including:
an API request payload constructed based on the API request schema and including valid values for required fields in the API request schema; and
one or more mock dependency API responses constructed based on the mock dependency API response schema and including valid values for required fields in the mock dependency API response schema;
generating an API request to the API with each candidate solution to obtain one or more corresponding output values for the one or more target output fields;
determining a fitness score of each candidate solution by measuring a distance between the one or more corresponding output values and target values for the one or more target output fields;
adjusting, using the machine learning optimization algorithm, based on corresponding fitness scores, the plurality of candidate solutions to reduce an expected distance between the one or more corresponding output values and target values for the one or more target output fields; and
iteratively repeating generating the API request, determining the fitness score of each candidate solution, and adjusting the plurality of candidate solutions until the machine learning optimization algorithm converges on a final candidate solution.

3. The method of claim 2, wherein the API request schema defines structure and format of data to be included in an API request to the API, including required fields, data types, and field constraints, further comprising:
validating, for each candidate solution, proposed values for required fields in the API request payload based on data types and field constraints from the API request schema.

4. The method of claim 2, wherein the mock dependency API response schema defines structure and format of data expected to be returned by one or more mock dependency APIs, including required fields, data types, and field constraints, further comprising:
validating, for each candidate solution, proposed values for required fields in the one or more mock dependency API responses based on data types and field constraints from the mock dependency API response schema.

5. The method of claim 2, wherein generating the plurality of candidate solutions comprises:
randomly generating initial values for required fields in the API request payload and the one or more mock dependency API responses based on field constraints in the API request schema and the mock dependency API response schema, respectively.

6. The method of claim 2, further comprising:
executing one or more test cases based on the final candidate solution and corresponding API request payload and mock dependency API responses.

7. The method of claim 2, further comprising:
applying a weighted scoring system to prioritize a portion of the one or more target output fields over others based on corresponding weights.

8. The method of claim 2, wherein adjusting the plurality of candidate solutions comprises:
introducing random mutations to the plurality of candidate solutions to expand a search space of potential solutions.

9. The method of claim 2, wherein adjusting the plurality of candidate solutions comprises:
using one or more crossover techniques, combining elements from multiple candidate solutions to create new candidate solutions.

10. The method of claim 2, wherein the machine learning optimization algorithm converges on the final candidate solution when a termination condition is met based on a predefined number of iterations or based on the final candidate solution being within a threshold fitness score.

11. The method of claim 2, further comprising:
dropping output values from a live version of a mocked API from the mock dependency API response schema.

12. The method of claim 2, wherein generating the API request to the API with each candidate solution comprises generating the API request for transmission to a virtualization server configured to execute the API.

13. One or more non-transitory, computer-readable media comprising instructions that, when executed by one or more processors, cause operations comprising:
receiving an API request schema for an API and a target output field and corresponding value for the API;
generating, using a machine learning optimization algorithm, a plurality of candidate solutions, each candidate solution including an API request payload constructed based on the API request schema and including valid values for required fields in the API request schema;
generating an API request to the API with each candidate solution to obtain one or more corresponding output values for the target output field;
determining a fitness score of each candidate solution;
adjusting, using the machine learning optimization algorithm, based on corresponding fitness scores, the plurality of candidate solutions; and
iteratively repeating generating the API request, determining the fitness score of each candidate solution, and adjusting the plurality of candidate solutions until the machine learning optimization algorithm converges on a final candidate solution.

14. The one or more non-transitory, computer-readable media of claim 13, wherein the API request schema defines structure and format of data to be included in an API request to the API, including required fields, data types, and field constraints, further comprising:
validating, for each candidate solution, proposed values for required fields in the API request payload based on data types and field constraints from the API request schema.

15. The one or more non-transitory, computer-readable media of claim 13, wherein generating the plurality of candidate solutions comprises:
randomly generating initial values for required fields in the API request payload based on field constraints in the API request schema.

16. The one or more non-transitory, computer-readable media of claim 13, further comprising:
executing one or more test cases based on the final candidate solution and corresponding API request payload.

17. The one or more non-transitory, computer-readable media of claim 13, wherein adjusting the plurality of candidate solutions comprises:
introducing random mutations to the plurality of candidate solutions to expand a search space of potential solutions.

18. The one or more non-transitory, computer-readable media of claim 13, wherein adjusting the plurality of candidate solutions comprises:
using one or more crossover techniques, combining elements from multiple candidate solutions to create new candidate solutions.

19. The one or more non-transitory, computer-readable media of claim 13, wherein the machine learning optimization algorithm converges on the final candidate solution when a termination condition is met based on a predefined number of iterations or based on the final candidate solution being within a threshold fitness score.

20. The one or more non-transitory, computer-readable media of claim 13, wherein generating the API request to the API with each candidate solution comprises generating the API request for transmission to a virtualization server configured to execute the API.
